(19) United States
(12) Patent Application Publication
(10) Pub. No.: US 2014/0214519 A1
(43) Pub. Date: Jul. 31, 2014

(54) PRODUCT SCOUT PLATFORM METHODS, APPARATUSES AND MEDIA

(71) Applicant: Gene Ekster, New York, NY (US)

(72) Inventor: Gene Ekster, New York, NY (US)

(21) Appl. No.: 13/778,358

(22) Filed: Feb. 27, 2013

Related U.S. Application Data
(60) Provisional application No. 61/604,113, filed on Feb. 28, 2012.

(51) Int. Cl. G06Q 30/02

(52) U.S. Cl. CPC G06Q 30/0234
USPC 705/14.34

(57) ABSTRACT

A rebate fulfillment request may be obtained from a user. A determination may be made that an offer associated with the rebate fulfillment request is unlocked for the user. Data may be validated to ensure that offer terms associated with the offer are satisfied. A rebate associated with the rebate fulfillment request may be approved and rebate fulfillment for the rebate may be facilitated.

### CROSS-REFERENCE TO RELATED APPLICATIONS

Applicant hereby claims priority under 35 U.S.C. §119 to U.S. provisional patent application No. 61/604,113, filed Feb. 28, 2012, entitled “PRODUCT SCOUT PLATFORM METHODS, APPARATUSES AND MEDIA,” docket no. 1100-101PV.

The entire contents of the aforementioned application are herein expressly incorporated by reference in their entirety.

This disclosure describes PRODUCT SCOUT PLATFORM METHODS, APPARATUSES AND MEDIA (hereinafter “PSP”). A portion of the disclosure of this patent document contains material which is subject to copyright and/or mask work protection. The copyright and/or mask work owners have no objection to the facsimile reproduction by anyone of the patent document or the patent disclosure, as it appears in the Patent and Trademark Office patent file or records, but otherwise reserve all copyright and mask work rights whatsoever.

### FIELD

The present disclosure is directed generally to marketing platforms.

### BACKGROUND

A variety of marketing techniques are available to advertisers. Some advertisers use TV advertisements, print advertisements and Internet advertisements to inform consumers regarding their products. Furthermore, some advertisers use paper or digital coupons to provide an incentive for a consumer to purchase their products.

### BRIEF DESCRIPTION OF THE FIGURES

The accompanying figures and/or appendices illustrate various exemplary embodiments in accordance with the present disclosure.

FIG. 1 shows an exemplary usage scenario in one embodiment of the PSP.

FIG. 2 shows a screen shot diagram illustrating an exemplary application screen in one embodiment of the PSP.

FIG. 3 shows a screen shot diagram illustrating an exemplary application screen in one embodiment of the PSP.

FIG. 4 shows a screen shot diagram illustrating an exemplary application screen in one embodiment of the PSP.

FIG. 5 shows a screen shot diagram illustrating an exemplary application screen in one embodiment of the PSP.

FIG. 6 shows a screen shot diagram illustrating an exemplary application screen in one embodiment of the PSP.

FIG. 7 shows a screen shot diagram illustrating an exemplary application screen in one embodiment of the PSP.

FIG. 8 shows a screen shot diagram illustrating an exemplary application screen in one embodiment of the PSP.

FIG. 9 shows an exemplary rebate fulfillment data flow diagram in one embodiment of the PSP.

FIG. 10 shows a logic flow diagram illustrating an exemplary rebate fulfillment (RF) component in one embodiment of the PSP.

FIG. 11 shows an exemplary information acquisition data flow diagram in one embodiment of the PSP.

FIG. 12 shows a logic flow diagram illustrating an exemplary information acquisition (IA) component in one embodiment of the PSP.

FIG. 13 shows a block diagram illustrating an exemplary PSP coordinator in one embodiment of the PSP.

### DETAILED DESCRIPTION

### Introduction

The PSP introduces a new type of marketing platform that facilitates product purchases by providing relevant geolocation information, product information (e.g., product description, product brand, product size, product pricing, and/or the like), offers (e.g., rebates (e.g., mail-in rebates, instant rebates), coupons (e.g., digital coupons), product discounts, gift cards, free products (e.g., branded merchandise, free drinks), event admissions (e.g., invites to VIP events, admissions to clubs), access to exclusive mailing lists, application downloads, PSP points, digital tickets (e.g., an animation that plays for a limited amount of time that can be shown to a vendor to gain free entrance to a club or to get a free drink), and/or the like), social network information, and/or the like. In some embodiments, the PSP may be used to obtain geolocation information (e.g., name, address, directions, phone number, website link, working hours, reviews, product information for carried products, and/or the like) regarding various locations (e.g., stores, restaurants, bars, clubs, movie theaters, service providers, and/or the like). For example, such information may be obtained by offering users PSP points and/or instant rewards (e.g., unlocked offers) for providing such information via a mobile PSP application. In some embodiments, the PSP may be used to provide geolocation information to users. For example, a user searching for a product via a mobile PSP application may be provided with a map that shows nearby locations that carry the product and geolocation information associated with those locations. In some embodiments, the PSP may be used to provide users with offers to facilitate product purchases. For example, the PSP may provide users with offers valid at nearby locations via a mobile PSP application, and users may use PSP points (e.g., obtained by providing geolocation information, demographic information, social network information, by using the mobile PSP application, and/or the like) to unlock these offers. In another example, the PSP may provide users with unlocked offers (e.g., a digital coupon).

### Detailed Description of the PSP

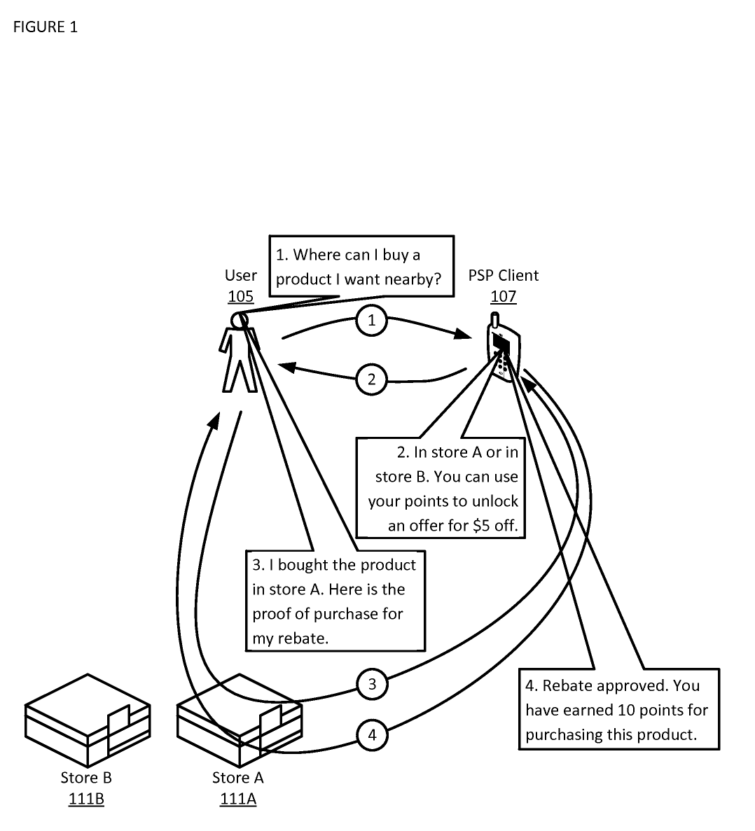

FIG. 1 shows an exemplary usage scenario in one embodiment of the PSP. In FIG. 1, a user 105 may use a PSP client 107 (e.g., a mobile device such as a smart phone, a tablet, and/or the like running a mobile PSP application) to locate stores 111A, 111B that carry a product, and to obtain a rebate for purchasing the product. For example, the user may query the PSP client for stores that carry the product desired by the user. The PSP client may provide a map that shows nearby stores that carry the product and/or relevant offers available to the user (e.g., $5 off the purchase price of the product). In one embodiment, the user may have to use PSP points to unlock the offer. In another embodiment, the offer may be unlocked. The user may wish to take advantage of the offer and may visit a store 111A to purchase the product. The user may provide proof of purchase (e.g., provide a scan of the product's identifier such as a barcode, a QR code, and/or the like, and a picture of the receipt via the PSP client) to the PSP to verify that the user fulfilled the terms of the offer. Upon verification, the PSP may approve and/or fulfill the rebate (e.g., credit the user's account $5, send a check for $5, and/or the like). The PSP may also award the user PSP points (e.g., 10 points) for purchasing the product and/or for taking advantage of the offer.

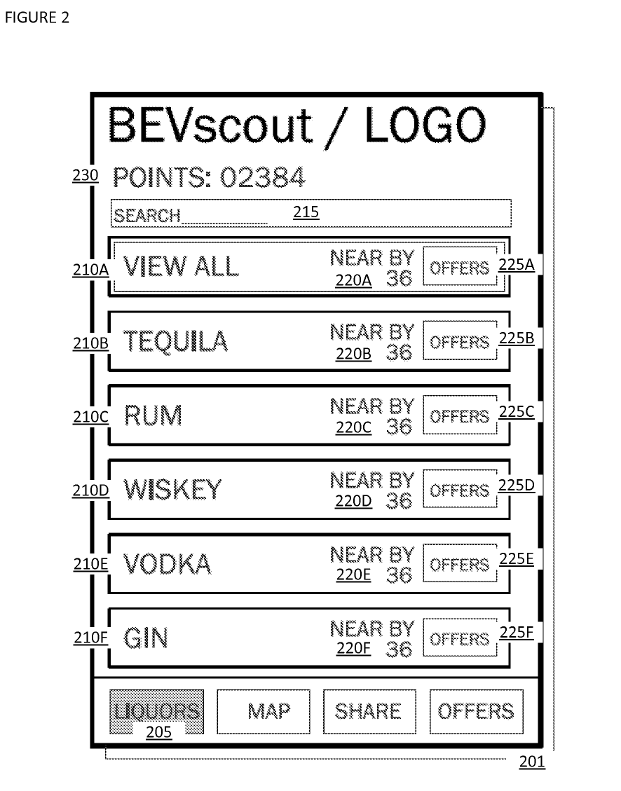

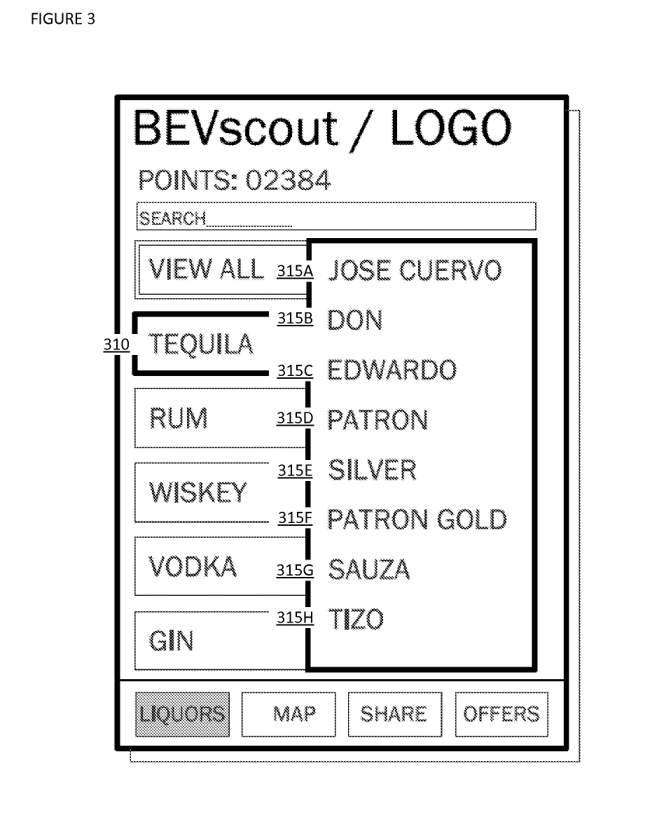

FIG. 2 shows a screen shot diagram illustrating an exemplary application screen in one embodiment of the PSP. In FIG. 2, a user may utilize a liquors application screen 201 to search for locations that carry a product (e.g., a liquor) desired by the user. It is to be understood that the PSP may be used to search for locations that carry any type of product (including services) and not just liquors, and that the use of liquors as products is an exemplary non-limiting embodiment. The user may use a liquors button 205 to view the liquors application screen. In one embodiment, the user may search for locations that carry any of the products supported by the PSP and/or by an application screen (e.g., by using the VIEW ALL widget 210A). In another embodiment, the user may search for specific categories of products (e.g., by using the product type widgets 210B-F). In yet another embodiment, as illustrated in FIG. 3, the user may further refine the search via filters (e.g., based on product subcategories, product information, and/or the like). For example, the user may search for nearby locations that carry one or more user selected and/or specified brands of the tequila product category 310 via widgets 315A-H. In yet another embodiment, the user may search for specified products, product categories, product subcategories, and/or the like via a search widget 215. For example, the user may search for nearby locations that carry Gray Goose vodka by entering the search term “gray goose”.

The PSP may inform the user regarding the number of nearby locations that carry various products. For example, the PSP may inform the user via an indicator 220A that 36 locations carry at least one product supported by the liquors application screen. In another example, the PSP may inform the user via indicators 220B-F regarding the number of locations that carry products in their respective product categories (e.g., 36 locations carry products in tequila product category).

The user may view offers available for various products and/or locations. For example, the user may use button 225A to view offers for any of the products supported by the liquors application screen. In another example, the user may use buttons 225B-F to view offers associated with their respective product categories. In some implementations, an offer may be shown to the user if that offer is available in at least one of the nearby locations.

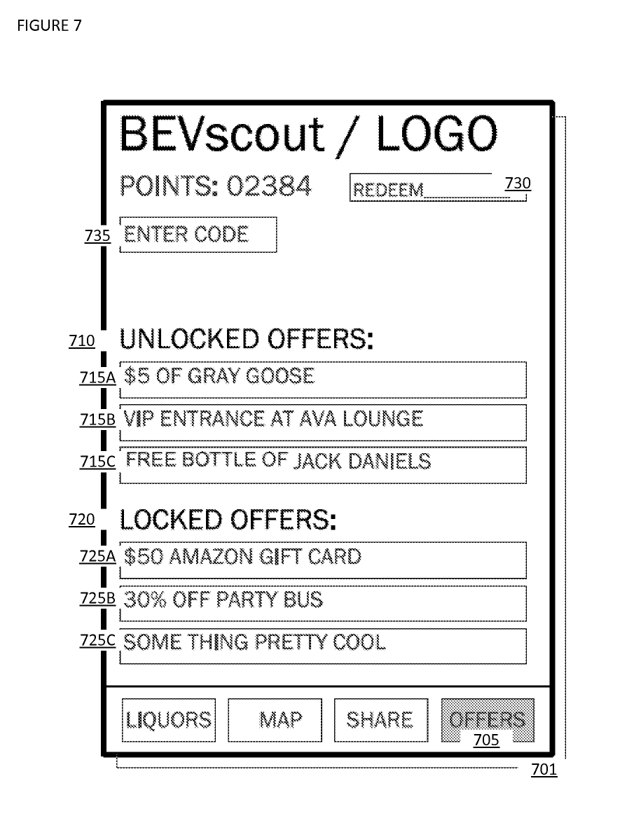

The PSP may inform the user regarding the number of PSP points available to the user (e.g., via an indicator 230). The PSP points may be used to access, obtain, unlock, trade and/or the like offers available via the PSP. See FIG. 7 for additional details regarding offers.

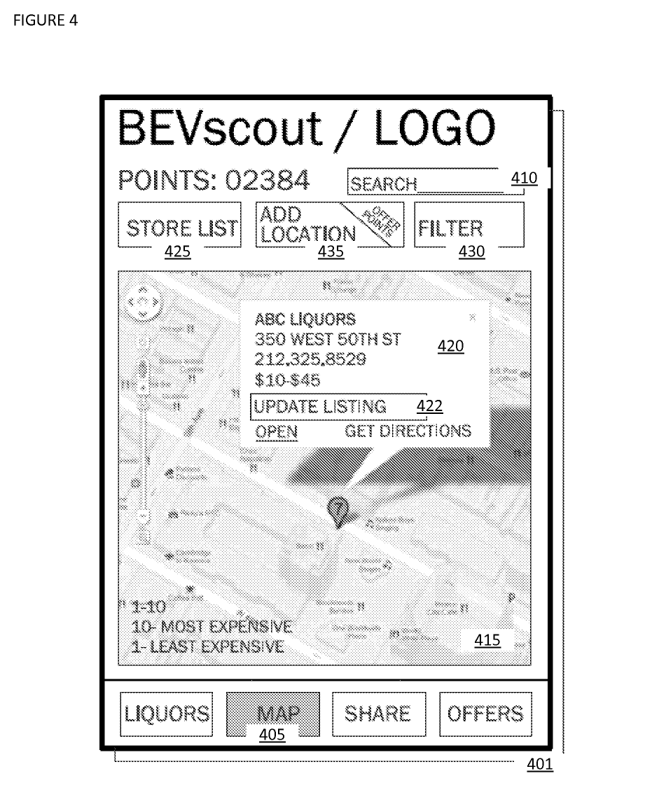

FIG. 4 shows a screen shot diagram illustrating an exemplary application screen in one embodiment of the PSP. In FIG. 4, a user may utilize a map application screen 401 to view relevant locations. For example, the user may use a map button 405 to view the map application screen. In another example, the user may be shown the map application screen upon using one of the widgets 210A-F, 315A-H, and/or the like to search for locations that carry a specified product. In one embodiment, the user may view nearby locations based on a product search (as described with regard to FIG. 2). In another embodiment, the user may scroll a map to view locations in a geographic area of the user's choice. In yet another embodiment, the user may use a search widget 410 to search for locations satisfying the user's search criteria (e.g., based on matching the user's search terms with geolocation information associated with locations).

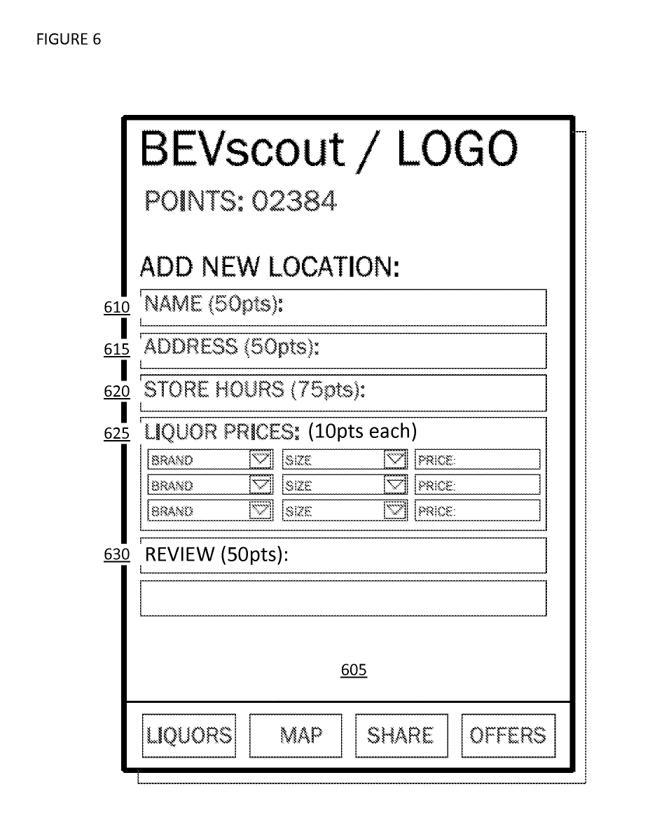

The PSP may use a map subcomponent 415 (e.g., Google Maps, Yahoo! Maps, a custom built map application, and/or the like) to display relevant locations. The map subcomponent may be configured to provide a variety of information (e.g., geolocation information regarding the relevant locations). In one implementation, the map subcomponent may provide an indicator of relevancy of a location (e.g., based on geolocation information, breadth of product selection, proximity, pricing of a searched for product, location rank according to reviews, and/or the like). For example, a marker representing a location may include a number indicating relevancy of the location (e.g., with 1 being most relevant). In another implementation, the map subcomponent may provide geolocation information regarding a selected location (e.g., via an additional information widget 420). For example, the additional information widget may provide geolocation information such as location name, location address, location phone number, location working hours, location pricing indicator (e.g., range of prices for tequila products specified by the user, a price index of products sold at a location, and/or the like), pricing of a searched for product, a link to the selected location's website, a link to get directions to the selected location (e.g., from the user's current position), and/or the like. In another example, the map subcomponent may facilitate maintenance of up-to-date location data by providing a way for the user to update such location data (e.g., geolocation information), such as via an update listing button 422. See FIG. 6 for additional details regarding adding a new location and/or updating location data.

The user may use the PSP to view a list of relevant locations (e.g., by using a store list button 425). For example, the user may view a list of nearby liquor stores that carry user specified products. In another example, the user may view a list of locations closest to the user's current location. In various implementations, the user may interact with list items representing locations to view additional information regarding a selected location (e.g., geolocation information), to view a selected location on a map (e.g., via the map subcomponent), to make a phone call to a selected location (e.g., via a PSP client), to update location data associated with a selected location, to view the price of a searched for product, and/or the like.

Product pricing information used by the PSP (e.g., to display pricing information for a location, to calculate a price index of products sold at a location) may be actual information and/or projected information. In one embodiment, product pricing information may be actual information (e.g., based on input from PSP users, data provided by a location, data provided by a manufacturer, and/or the like). In another embodiment, product pricing information may be projected information (e.g., based on a statistical model that estimates prices). For example, if the PSP does not have the price of a product for a location, the PSP may estimate the price of the product for the location to be the average of prices for the product at three locations closest to the location.

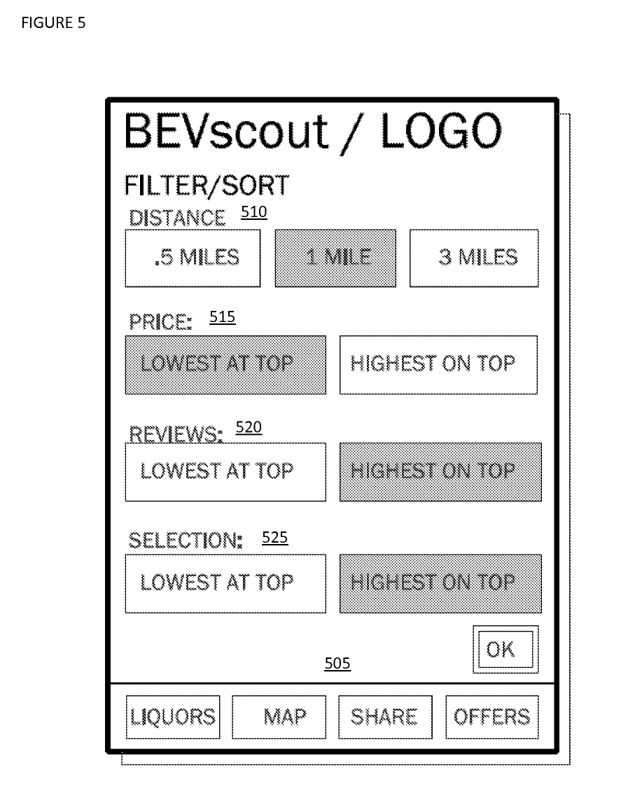

The user may filter and/or sort relevant locations via a filter button 430. See FIG. 5 for additional details regarding filtering and/or sorting relevant locations. The user may also add new locations via an add location button 435. The user may be rewarded with PSP points and/or instant rewards (e.g., unlocked offers) for adding a new location and/or updating location data. See FIG. 6 for additional details regarding adding a new location and/or updating location data.

FIG. 5 shows a screen shot diagram illustrating an exemplary application screen in one embodiment of the PSP. In FIG. 5, the user may utilize a filter/sort dialog 505 to filter and/or sort relevant locations. In one embodiment, the user may use the filter/sort dialog to filter locations based on one or more filter criteria such as geolocation information, breadth of product selection, proximity, pricing of a searched for product, location rank according to reviews, and/or the like. For example, the user may use a distance filter 510 to indicate that the PSP may consider relevant locations to be those that are no more than one mile away from the user's current location. In another embodiment, the user may use the filter/sort dialog to sort locations based on one or more sort criteria such as geolocation information, breadth of product selection, proximity, pricing of a searched for product, location rank according to reviews, and/or the like. For example, the user may use a price filter 515, a reviews filter 520, and a selection filter 525 to indicate that the PSP may sort relevant locations progressively, first by the price of a searched for product (e.g., locations with lower prices are more relevant), second by the average review score associated with a location (e.g., locations with better review scores are more relevant), and third by breadth of product selection associated with a location (e.g., locations that carry more brands, types, vintage years, bottle volume sizes, and/or the like of a searched for product are more relevant). It is to be understood that depending on implementation, a variety of filter and/or sort criteria may be used, these criteria may be used independently, in combinations, and/or progressively, and the order in which these criteria are applied may be varied (e.g., by the PSP, by the user, and/or the like).

FIG. 6 shows a screen shot diagram illustrating an exemplary application screen in one embodiment of the PSP. In FIG. 6, the user may utilize a location dialog 605 to add location data regarding a new location and/or update location data for an existing location. The user may provide such location data to facilitate integration of such location data into PSP data stores, which may result in improved quality of responses (e.g., more accurate information about more locations) for PSP users. The PSP may also reward the user (e.g., with PSP points, with instant rewards) for providing such location information. In one implementation, the PSP may prompt the user to provide general location information about a location (e.g., location name, location address, location phone number, location working hours, and/or the like). For example, the PSP may prompt the user to provide information regarding the name, address and store hours associated with a location via a name widget 610, an address widget 615, and a store hours widget 620, respectively. The PSP may reward the user with 50, 50 and 75 PSP points, respectively, for providing such information. In another implementation, the PSP may prompt the user to provide product information regarding products carried by a location. For example, the PSP may prompt the user to provide information regarding brands, types, vintage years, bottle volume sizes, prices, and/or the like via a liquor prices widget 625. The PSP may reward the user with 10 PSP points for each product information data field provided by the user. In yet another implementation, the PSP may prompt the user to review a location. For example, the PSP may prompt the user to provide an open-ended review, a rating of specified qualitative and/or quantitative factors, an overall rating, and/or the like via a review widget 630. The PSP may reward the user with 50 PSP points for providing a review. It is to be understood that the PSP may prompt the user to enter a variety of location data depending on location data of interest to the PSP (e.g., one user may be prompted to provide information regarding different brands of vodka carried by a club, while another regarding different brands of rum) and/or may vary rewards for providing location data (e.g., depending on the level of PSP interest in such data). Furthermore, the PSP may vary and/or decline to offer rewards based on the quality of information provided by the user. For example, if a user repeatedly provides low quality (e.g., inaccurate, incorrect) information, the PSP may offer the user few PSP points and/or may decline to offer the user any rewards for providing information.

FIG. 7 shows a screen shot diagram illustrating an exemplary application screen in one embodiment of the PSP. In FIG. 7, a user may utilize an offers application screen 701 to view, unlock, redeem, and/or the like available offers. For example, the user may use an offers button 705 to view the offers application screen. In another example, the user may be shown the offers application screen upon using one of the widgets 225A-F, and/or the like to view offers for a specified product.

In one embodiment, offers presented by the PSP may be available for general consumption. In another embodiment, offers presented by the PSP may have to be unlocked before the user may take advantage of the offers. For example, the PSP may present the user with unlocked offers 710, which include unlocked offers 715A-C, and with locked offers 720, which include locked offers 725A-C. In one implementation, the user may unlock locked offers by redeeming PSP points (e.g., via a redeem widget 730). For example, the user may redeem 5,000 PSP points to unlock locked offer 725A for a $50 Amazon.com gift card. In another implementation, the user may unlock locked offers by performing an action such as entering a code (e.g., via an enter code widget 735), entering a URL, scanning a code (e.g., a promotional QR code from a magazine page, advertising poster, billboard), sharing information with friends (e.g., telling friends about the PSP via a social network), scanning a product's bar code (e.g., scanning a bottle of Veev at a liquor store), taking a survey (e.g., answering demographic questions), making a video (e.g., using a PSP partner's app to make a video and sharing the video with friends via a social network), following a PSP partner (e.g., following a PSP partner on Facebook or Twitter), showing up and/or checking in (e.g., via Foursquare, by scanning a QR code) at a location or event, adding a calendar event (e.g., a reminder to take a hangover cure pill the next morning). For example, the user may provide geographic coordinates to prove that the user is at a specified location to unlock a locked offer 725B for 30% off party bus admission. In yet another implementation, the user may unlock an offer by taking advantage of another offer. For example, the user may unlock a locked offer 725C for something pretty cool by taking advantage of an unlocked offer 715A for $5 off Gray Goose vodka. In yet another embodiment, offers presented by the PSP may be hidden. For example, if the user takes advantage of unlocked offer 715B for VIP entrance at Ava Lounge, the PSP may reward the user be by revealing a hidden offer 715C for a free bottle of Jack Daniels whiskey.

The PSP may present different users with different offers. In one embodiment, the PSP may choose which offers to present to the user based on the user's prior behavior (e.g., brands, types, alcohol percentage, and/or the like of products previously purchased by the user). For example, if the user shows a preference for whiskey, the user may be provided with offers related to whiskey. In another example, if the user usually buys one brand of vodka, the user may be provided with offers to try a different brand of vodka. In another embodiment, the PSP may choose which offers to present to the user based on the user's location. For example, the user may be presented with offers that the user may redeem at one of the nearby locations. In yet another embodiment, the PSP may choose which offers to present to the user based on the user's client. For example, iPhone users may be presented with one set of offers, while Blackberry users may be presented with another set of offers. In another example, some offers may be exclusive to certain clients (e.g., some offers may be available exclusively to users using Android clients). In some embodiments, prior to rewarding the user for fulfilling the terms of an offer, the PSP may present the user with an opportunity to earn additional rewards. For example, prior to rewarding the user with a coupon for a free drink for scanning a QR code at a club, the PSP may prompt the user to share his location on Facebook to earn 10 PSP points. It is to be understood that the PSP may use a variety of methods and/or combinations of methods to choose which offers to present to the user and that some offers may not be available in some locations and/or during certain times in compliance with applicable federal, state, and local regulations.

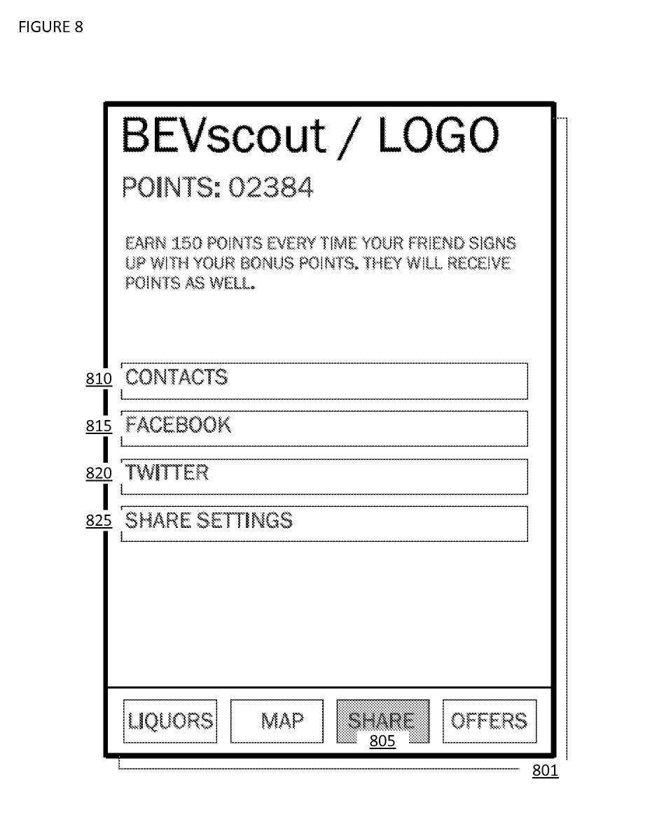

FIG. 8 shows a screen shot diagram illustrating an exemplary application screen in one embodiment of the PSP. In FIG. 8, a user may utilize a share application screen 801 to share PSP related data with the user's social network. For example, the user may use a share button 805 to view the share application screen. In various embodiments, the user may be able to invite another user to sign up with the PSP, to share the user's location, offers, points, redemption history, intent to take advantage of an offer (e.g., intent to take advantage of a VIP admission offer to a bar on a particular day), and/or the like. For example, the user may invite a contact (e.g., a contact in the PSP client's phone book, an email contact, and/or the like) to join the PSP via a contacts widget 810. In another example, the user may give some of the user's PSP points and/or instant rewards (e.g., unlocked offers) to a Facebook friend via a Facebook widget 815. In yet another example, the user may post about a PSP offer the user liked on Twitter via a Twitter widget 820. In some embodiments, the user may configure the user's share settings (e.g., via a share settings widget 825). Share settings may include information regarding what, how, when, and/or the like the user wishes to share. For example, the user may specify those friends with which the user wishes to share the user's location. In another example, the user may specify whether and what kind of data the PSP may post to the user's Facebook wall. The PSP may reward the user for sharing PSP related data with PSP points, instant rewards (e.g., unlocked offers), new offers, unlocking of hidden offers, achievement badges, and/or the like.

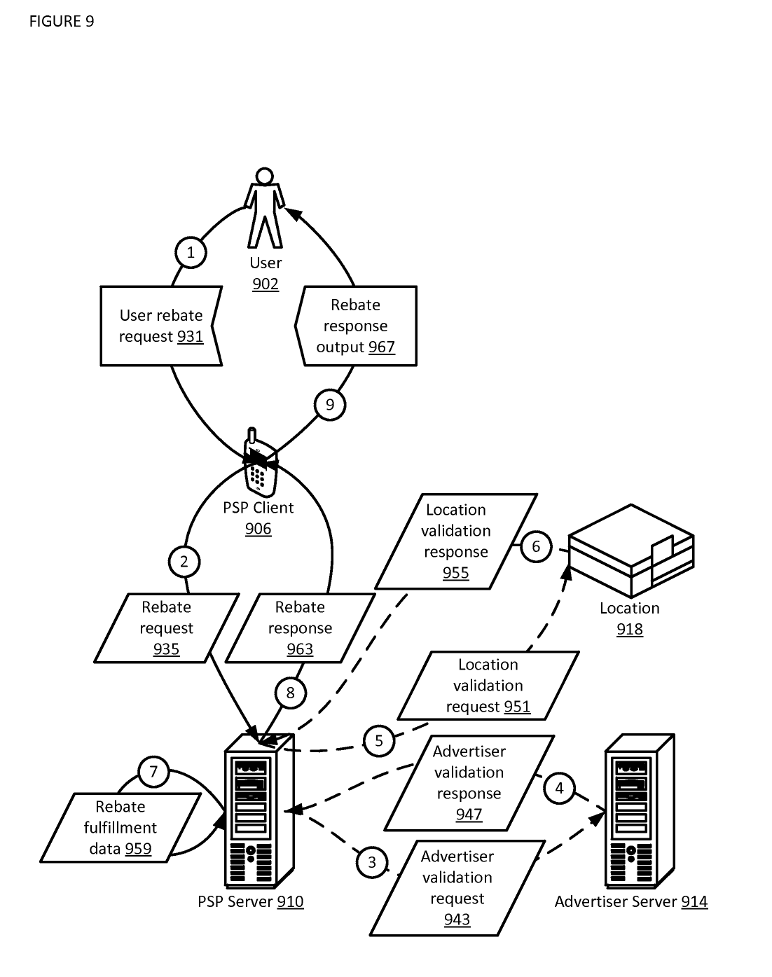

FIG. 9 shows an exemplary rebate fulfillment data flow diagram in one embodiment of the PSP. In FIG. 9, dashed arrows indicate data flow elements that may be more likely to be optional. FIG. 9 provides an example of how data may flow to, through, and/or from the PSP when a user wishes to take advantage of an offer to receive a rebate on a product purchase (e.g., $5 off Gray Goose vodka). In FIG. 9, the user 902 may input a user rebate request 931 into a PSP client 906 to receive the $5 rebate. For example, the user rebate request may include data such as a user identifier, a password, a selection of an offer, a scan of a product identifier, an image of a receipt, and/or the like. The PSP client may communicate with a PSP server 910 to provide a rebate request 935 to the PSP server. For example, the rebate request may include data such as a user identifier, a password, a client identifier, an offer identifier, a product identifier, an image of a receipt, a rebate request submission date and/or time, and/or the like. In one implementation, the rebate request may be in XML format substantially in the following form:

<XML>

<RebateRequest>

<UserID>ID_User1</UserID>
<Password>password</Password>
<ClientID>ID_Client1</ClientID>
<OfferDetails>

<OfferID>ID_Offer123</OfferID>
<ProductID>ID_Product456</ProductID>

</OfferDetails>
<RequestDetails>

<Receipt>image of receipt</Receipt>
<SubmissionDateTime>July 1, 2013
11:00:00am</SubmissionDateTime>

</RequestDetails>

</RebateRequest>

</XML>

Handling the rebate request may include validating the rebate request via the PSP server. In one embodiment, the PSP server may send an advertiser validation request 943 to an advertiser server 914. The PSP server may contact the advertiser server to confirm whether a rebate offer is in effect, whether a product is eligible, whether a user is eligible, and/or the like. For example, the advertiser validation request may include data such as login credentials of the PSP server, a user identifier, an offer identifier, a product identifier, a rebate request submission date and/or time, and/or the like. In one implementation, the advertiser validation request may be in XML format substantially in the following form:

<XML>

<AdvertiserValidationRequest>

<LoginID>PSP_Server_Login_ID1</LoginID>
<UserID>ID_User1</UserID>
<OfferDetails>

<OfferID>ID_Offer123</OfferID>
<ProductID>ID_Product456</ProductID>

</OfferDetails>
<SubmissionDateTime>July 1, 2013
11:00:00am</SubmissionDateTime>

</AdvertiserValidationRequest>

</XML>

The advertiser server may respond with an advertiser validation response 947. For example, the advertiser validation response may indicate whether the rebate offer is a currently ongoing promotion validated by an advertiser. In one implementation, the advertiser validation response may be in XML format substantially in the following form:

<XML>

<AdvertiserValidationResponse>

<OfferValidated>TRUE</OfferValidated>

</AdvertiserValidationResponse>

</XML>

In another embodiment, the PSP server may send a location validation request 951 to a location 918. The PSP server may contact the location to confirm whether a user purchased a product from the location, what price a user paid for a product, when a user purchased a product, and/or the like. For example, the location validation request may include data such as login credentials of the PSP server, a receipt identifier, a receipt image, product pricing, product quantity, purchase date and/or time, and/or the like. In one implementation, the location validation request may be in XML format substantially in the following form:

<XML>

<LocationValidationRequest>

<LoginID>PSP_Server_Login_ID1</LoginID>
<RequestDetails>

<ReceiptID>Receipt_No_1</ReceiptID>
<Receipt>image of receipt</Receipt>
<ProductID>ID_Product456</ProductID>
<ProductPrice>$29.99</ProductPrice>
<ProductQuanitity>2</Product Quantity>
<PurchaseDateTime>June 1, 2013
11:00:00am</PurchaseDateTime>

</RequestDetails>

</LocationValidationRequest>

</XML>

The location may respond with a location validation response 955. For example, the location validation response may indicate whether receipt data is valid. In one implementation, the location validation response may be in XML format substantially in the following form:

<XML>

<LocationValidationResponse>

<ReceiptValidated>TRUE</ReceiptValidated>

</LocationValidationResponse>

</XML>

It is to be understood that depending on implementation, validation of the rebate request by the advertiser server, location, and/or other entities may occur before, during, and/or after rebate fulfillment.

The PSP server may analyze rebate fulfillment data 959 to determine whether to approve the rebate. In various implementations, rebate fulfillment data may include eligibility analysis data (e.g., eligibility of a user, a client, a product, whether the terms of the rebate have been met, and/or the like), content of the advertiser validation response, content of the location validation response, image validation analysis data (e.g., result of analysis to determine whether a receipt is a forgery), duplicate analysis data (e.g., result of analysis to determine whether a receipt was already used to obtain a rebate), and/or the like.

The PSP server may communicate with the PSP client to provide a rebate response 963. For example, the rebate response may include an indication of whether the rebate is approved and/or fulfilled, a reference number associated with the rebate, a request to input additional data and/or to reenter provided data, an error notification, and/or the like. In one implementation, the rebate response may be in XML format substantially in the following form:

<XML>

<RebateResponse>

<RebateStatus>Approved</RebateStatus>
<ReferenceNumber>Reference_No_123</ReferenceNumber>
<ErrorCode>0 - No Errors</ErrorCode>

</RebateResponse>

</XML>

The PSP client may output a rebate response output 967 to the user. For example, the rebate response output may be a user interface output informing the user regarding the rebate approval decision, prompting the user to enter and/or reenter data, informing the user regarding an error, and/or the like.

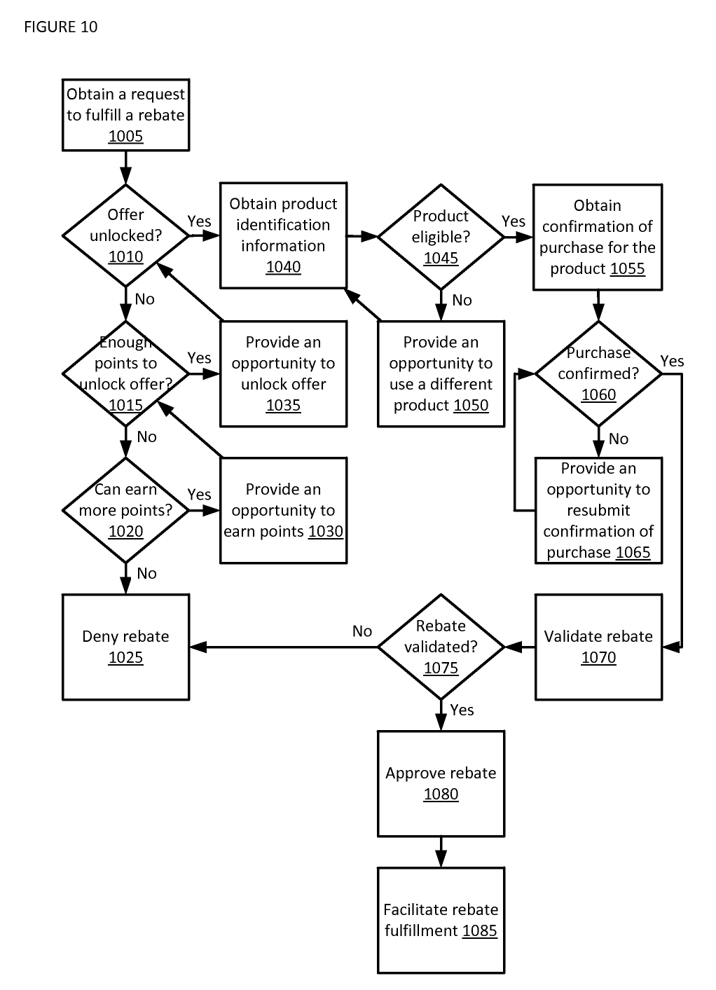

FIG. 10 shows a logic flow diagram illustrating an exemplary rebate fulfillment (RF) component in one embodiment of the PSP. For example, the RF component may be used to facilitate rebate fulfillment. In FIG. 10, a request to fulfill a rebate may be obtained at 1005. For example, the rebate fulfillment request may be obtained from a user via the PSP client. A determination may be made at 1010 whether the offer associated with the rebate is unlocked. For example, such a determination may be made by utilizing data regarding the user (e.g., stored in a users data store 1330a), the PSP client (e.g., stored in a clients data store 1330b), the offer (e.g., stored in an offers data store 1330c), and/or the like to determine whether the offer is unlocked for the user and/or for the user's PSP client (e.g., via one or more SQL statements, C++ statements, and/or the like).

If the offer is not unlocked, a determination may be made at 1015 whether the user has enough PSP points to unlock the offer. For example, the number of PSP points in the user's account may be compared to the cost to unlock the offer to make this determination. If the user does not have enough points to unlock the offer a determination may be made at 1020 whether the user can earn more PSP points. For example, the PSP may determine whether the user can earn more PSP points by providing geolocation information, demographic information, social network information, by using the mobile PSP application, and/or the like. If the user cannot earn enough PSP points to unlock the offer, the rebate fulfillment request may be denied at 1025. For example, the PSP may inform the user that the offer is locked. If the user can earn enough PSP points, the user may be provided with an opportunity to earn more PSP points at 1030. For example, the user may be prompted to provide information requested by the PSP in exchange for PSP points. If the user has enough PSP points to unlock the offer, the user may be provided with an opportunity to unlock the offer at 1035. For example, the user may be prompted to redeem PSP points to unlock the offer. In some embodiments, instead of using PSP points to unlock the offer, the user may perform a requested action to unlock the offer. For example, the PSP may prompt the user to complete a survey to unlock the offer.

If the offer is unlocked, the PSP may obtain product identification information for a product associated with the rebate at 1040. For example, the user may type in a product name, select a product from a list provided via the PSP client (e.g., based on information stored in a products data store 1330f), scan a product's identifier (e.g., a barcode, a QR code, and/or the like), take a picture of the product, and/or the like. A determination may be made at 1045 whether the product is eligible for the rebate. For example, the PSP may communicate with an advertiser associated with the product (e.g., based on information stored in an advertisers data store 1330d) to confirm whether the product is eligible for the rebate. If the product is not eligible for the rebate, the PSP may provide the user with an opportunity to reenter product identification information, to use a different product, and/or the like at 1050. If the product is eligible for the rebate, the PSP may obtain a confirmation of purchase for the product at 1055. For example, the user may provide an image of a receipt, a receipt identifier and/or the like to confirm product purchase. A determination may be made at 1060 whether the purchase of the product is confirmed. For example, the PSP may communicate with a location where the product was purchased (e.g., based on information stored in a locations data store 1330e) to confirm whether the product was purchased at the location. If the product purchase is not confirmed, the PSP may provide the user with an opportunity to resubmit confirmation of purchase (e.g., resend an image of a receipt, provide a different receipt identifier, and/or the like) at 1065.

If the product purchase is confirmed, the rebate may be validated at 1070. In one embodiment, the PSP may perform eligibility analysis, image validation analysis, barcode analysis, duplicate analysis, analysis of the user's history of rebate submissions, and/or the like to determine whether the rebate fulfillment request is valid. For example, the PSP may decline to validate the rebate fulfillment request if any of the analyses fail. In another example, the PSP may generate a validation score based on the performed analyses and may validate the rebate fulfillment request if the validation score exceeds an applicable threshold. In another embodiment, the PSP may analyze the quality of the user input associated with the rebate fulfillment request to determine whether the rebate fulfillment request is valid. For example, the PSP may track the quality of the images submitted by users and flag those users who submit low quality images that are difficult to validate via image validation analysis (e.g., this may result in a higher validation score threshold applicable to these users, banning of these users from receiving rebates, and/or the like).

A determination may be made at 1075 whether the rebate is validated. If the rebate is not validated, the rebate fulfillment request may be denied at 1025. For example, the PSP may inform the user that the user failed to meet some of the terms of the rebate. If the rebate is validated, the rebate fulfillment request may be approved at 1080. For example, the PSP may inform the user that the rebate is approved. The PSP may facilitate rebate fulfillment at 1085. For example, the PSP may facilitate reimbursement of the user according to the terms of the rebate by crediting (e.g., directly or via a third party) the user's PayPal account, sending payment (e.g., a check, a gift card, and/or the like) to the user's mailing address, crediting the user's PSP account (e.g., with money, PSP points, unlocked offers, digital coupons, and/or the like), providing merchandise (e.g., products, application downloads, digital tickets, and/or the like), and/or the like.

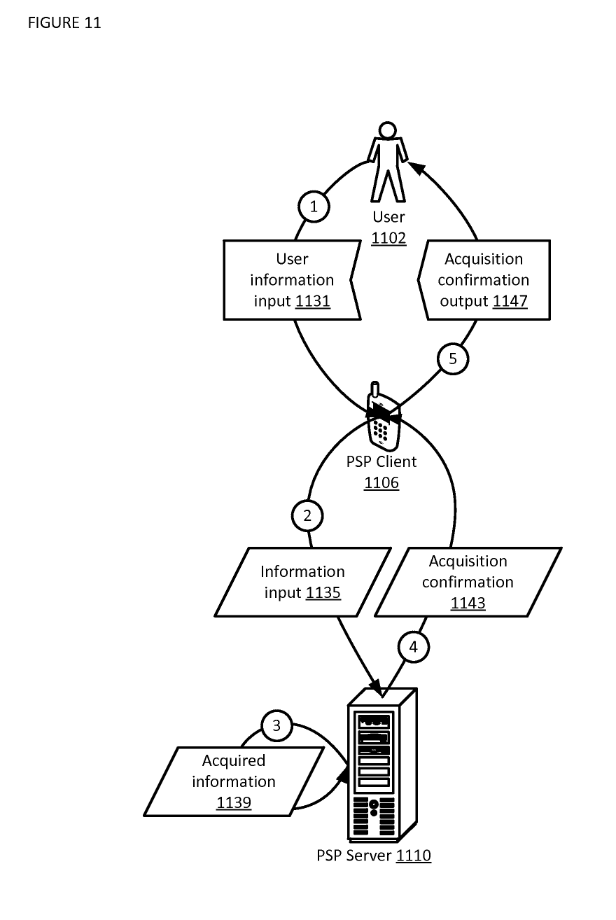

FIG. 11 shows an exemplary information acquisition data flow diagram in one embodiment of the PSP. FIG. 11 provides an example of how data may flow to, through, and/or from the PSP when the PSP acquires data (e.g., geolocation information, demographic information, social network information, and/or the like) from a user. In FIG. 11, the user 1102 may provide a user information input 1131 to the PSP client 1106 to obtain rewards such as PSP points (e.g., 30 PSP points for providing information regarding the cost of a one liter bottle of Gray Goose vodka at a location—10 points each for size, brand and price), instant rewards (e.g., unlocked offers), and/or the like. For example, the user information input may include data such as a user identifier, a password, a size, a brand, a price, a product identifier, a location identifier, and/or the like. The PSP client may communicate with a PSP server 1110 to provide an information input 1135 to the PSP server. For example, the information input may include data such as a user identifier, a password, a client identifier, a size, a brand, a price, a product identifier, a location identifier, information input submission date and/or time, and/or the like. In one implementation, the information input may be in XML format substantially in the following form:

<XML>

<InformationInput>

<UserID>ID_User1</UserID>
<Password>password</Password>
<ClientID>ID_Client1</ClientID>
<ProductDetails>

<ProductID>ID_Product456</ProductID>
<ProductCategory>Vodka</ProductCategory>
<Size>1 Liter</Size>
<Brand>Gray Goose</Brand>
<Price>$29.99</Price>

</ProductDetails>
<LocationID>ID_Location1</LocationID>
<SubmissionDateTime>July 1, 2013
11:00:00am</SubmissionDateTime>

</InformationInput>

</XML>

The PSP server may make use of the acquired information 1139 in a variety of ways. In one embodiment, the PSP server may integrate the acquired information with PSP data (e.g., stored in data stores 1330). For example, the PSP server may update pricing information for a product at a location (e.g., via one or more SQL queries). In another embodiment, the PSP server may use the acquired information to determine a reward to award to the user for providing the acquired information (e.g., based on a reward point amount and/or instant reward corresponding to the information type provided by the user). For example, the PSP server may award the user 30 PSP points. In another example, the PSP server may award the user with access to an exclusive mailing list.

The PSP server may communicate with the PSP client to provide an acquisition confirmation 1143. For example, the acquisition confirmation may include an indication that the PSP obtained user provided information, an indication that the user was awarded PSP points and/or an instant reward, a prompt to provide additional information, and/or the like. In one implementation, the acquisition confirmation may be in XML format substantially in the following form:

<XML>

<AcquisitionConfirmation>

<InfoReceived>TRUE</InfoReceived>
<PSPPointsAwarded>30</PSPPointsAwarded>

</AcquisitionConfirmation>

</XML>

The PSP client may output an acquisition confirmation output 1147 to the user. For example, the acquisition confirmation output may be a user interface output thanking the user for providing information, updating the user's PSP points balance in a mobile PSP application, providing a digital ticket to the user, prompting the user to provide additional information, informing the user regarding an error, and/or the like.

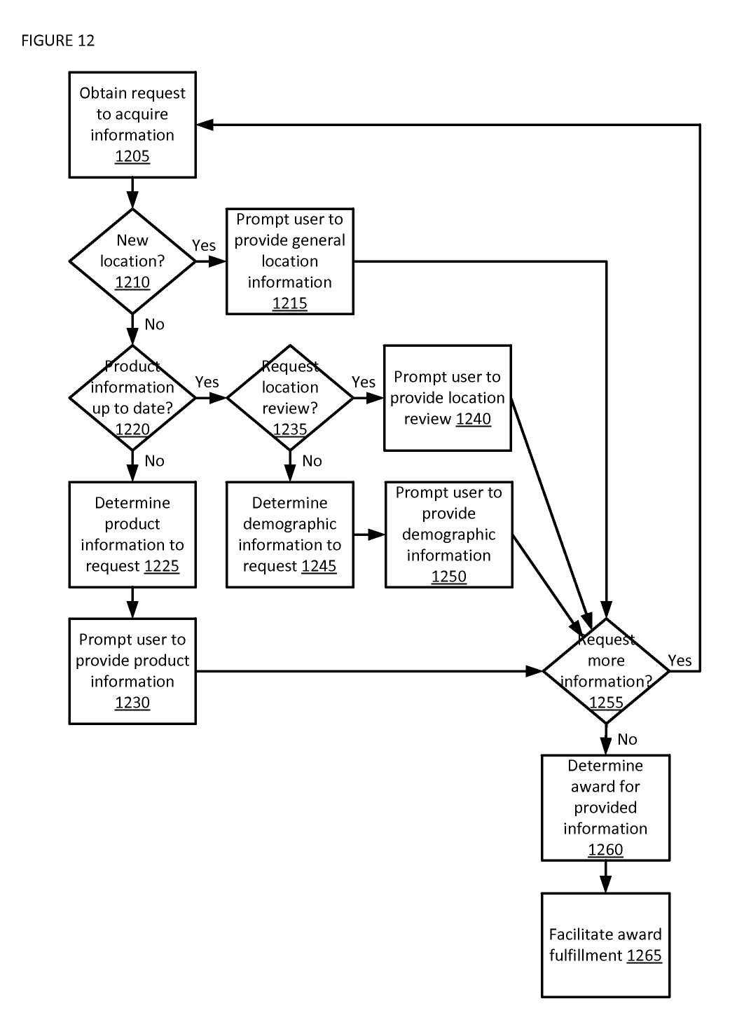

FIG. 12 shows a logic flow diagram illustrating an exemplary information acquisition (IA) component in one embodiment of the PSP. For example, the IA component may be used to facilitate information acquisition (e.g., geolocation information, demographic information, social network information, and/or the like) regarding a location. In FIG. 12, a request to acquire information may be obtained at 1205. In one embodiment, the request may be obtained as a result of a user volunteering to provide information (e.g., by clicking the update listing button 422). In another embodiment, the request may be obtained as a result of the PSP determining that the user should be queried (e.g., via a push notification) for information (e.g., the user is at a location for which the PSP wishes to obtain product pricing information for specified liquors, the PSP wishes to obtain demographic information about the user, and/or the like).

A determination may be made at 1210 whether the user is providing information for a new location or for a known location for which the PSP already has data. For example, such a determination may be made by comparing location coordinates, location name, and/or the like data known to the PSP (e.g., based on information stored in a locations data store 1330e) to the information provided by the user. If the user is providing information for a new location, the PSP may prompt the user to provide general location information for the location at 1215. For example, the PSP may let the user know via the PSP client that the user may earn free merchandise by providing general location information to the PSP. If the user is providing information for a known location, a determination may be made at 1220 whether product information for the location is up to date. For example, such a determination may be made by determining whether the length of time since the last product information update exceeds a specified threshold (e.g., not up to date if the last update was more than three days ago). In another example, such a determination may be made by determining whether the PSP has adequate product information for a location (e.g., if on average the PSP has product information for one hundred products per location, product information is up to date for a location for which the PSP has product information for more than one hundred products).

If product information for a location is not up to date, the PSP may determine which product information to request from the user at 1225. In one embodiment, the PSP may request product information for products for which the PSP has the least amount of data. For example, if the PSP has product information regarding vodka and rum sold at the location, the PSP may request product information regarding tequila sold at the location. In another embodiment, the PSP may request product information for products the prices of which tend to predict prices of other products sold at the location. For example, the PSP may use statistical techniques such as regression analysis (e.g., by analyzing data from locations for which product pricing information is available) to assess (e.g., by calculating indicators of predictability) how well the price of a product predicts prices of other products, and the PSP may request product information regarding the product that tends to predict prices of other products best (e.g., determined based on the value, for the product, of a summation of the indicators of predictability for other products at the location for which product pricing information is unavailable). Furthermore, the PSP may use various techniques (e.g., statistical machine learning techniques) to determine the number of PSP points and/or the instant reward (e.g., an unlocked offer) to offer to the user for providing requested product information. For example, the number of PSP points and/or the instant reward offered may be correlated with the amount of product information for a product that the PSP already has (e.g., the PSP may offer more PSP points and/or a more valuable instant reward for product information for a product for which the PSP has little product information), the degree of predictability associated with a product (e.g., the PSP may offer more PSP points and/or a more valuable instant reward for product information associated with a product that tends to predict prices of other products well), and/or the like.

The PSP may prompt the user to provide product information of interest to the PSP at 1230. For example, the PSP may let the user know via the PSP client that the user may earn PSP points by providing product information of interest to the PSP.

If product information for the location is up to date, a determination may be made at 1235 whether the PSP should request a location review from the user. In one embodiment, such a determination may be made based on the number of location reviews associated with the location. For example, if the location has fewer than five location reviews, the PSP may request a location review from the user. In another embodiment, such a determination may be made based on helpfulness of the user. For example, if most people who read the user's previous reviews found them helpful (e.g., based on information stored in a users data store 1330a), the PSP may request a location review from the user. If the PSP should request a location review from the user, the PSP may prompt the user to provide a location review for the location at 1240. For example, the PSP may let the user know via the PSP client that the user may unlock an offer by providing general location information to the PSP. If the PSP should not request a location review from the user, the PSP may determine demographic information to request from the user at 1245. For example, the PSP may request demographic information of interest to PSP partners and/or advertisers (e.g., based on information stored in an advertisers data store 1330d) such as age, gender, annual household income, number of drinks the user consumes on average during a night out, and/or the like. The PSP may prompt the user to provide demographic information at 1250. For example, the PSP may prompt the user to answer a demographic question while the user is using the PSP client and/or to proceed with the use of the PSP client.

A determination may be made at 1255 whether the PSP should request more information from the user. In one embodiment, such a determination may be made based on the amount of data already provided by the user. For example, if today the user provided product information regarding three products, the PSP may not wish to bother the user with requests for more information until the next day. In another embodiment, such a determination may be made based on accuracy of information provided by the user. For example, if the user tends to provide accurate information (e.g., based on comparison of information provided by the user with information provided by other users), the PSP may request more information from the user than from another user who tends to provide less accurate information. It is to be understood that information may be requested and/or provided in a variety of ways. For example, the user may be requested to respond to an individual question (e.g., a demographic question). In another example, the user may be prompted to provide multiple pieces of data (e.g., general location information, product information, and location review—as illustrated in FIG. 6). In yet another example, priority assigned by the PSP to requesting various pieces of information may vary depending on implementation.

If the PSP should request more information from the user, the user may be queried for more information at 1205; otherwise, the PSP may determine an award to provide to the user for the provided information at 1260 (e.g., based on information stored in an offers data store 1330c). For example, the PSP may sum PSP point values associated with providing various pieces of information to determine the total PSP point value for the provided information. In another example, the PSP may reward the user with an unlocked hidden offer. The PSP may facilitate award fulfillment at 1265. For example, the PSP may facilitate award fulfillment by crediting (e.g., directly or via a third party) the user's PayPal account, sending payment (e.g., a check, a gift card, and/or the like) to the user's mailing address, crediting the user's PSP account (e.g., with money, PSP points, unlocked offers, and/or the like), providing merchandise (e.g., products, application downloads, and/or the like), and/or the like.

### Detailed Description of the PSP Coordinator

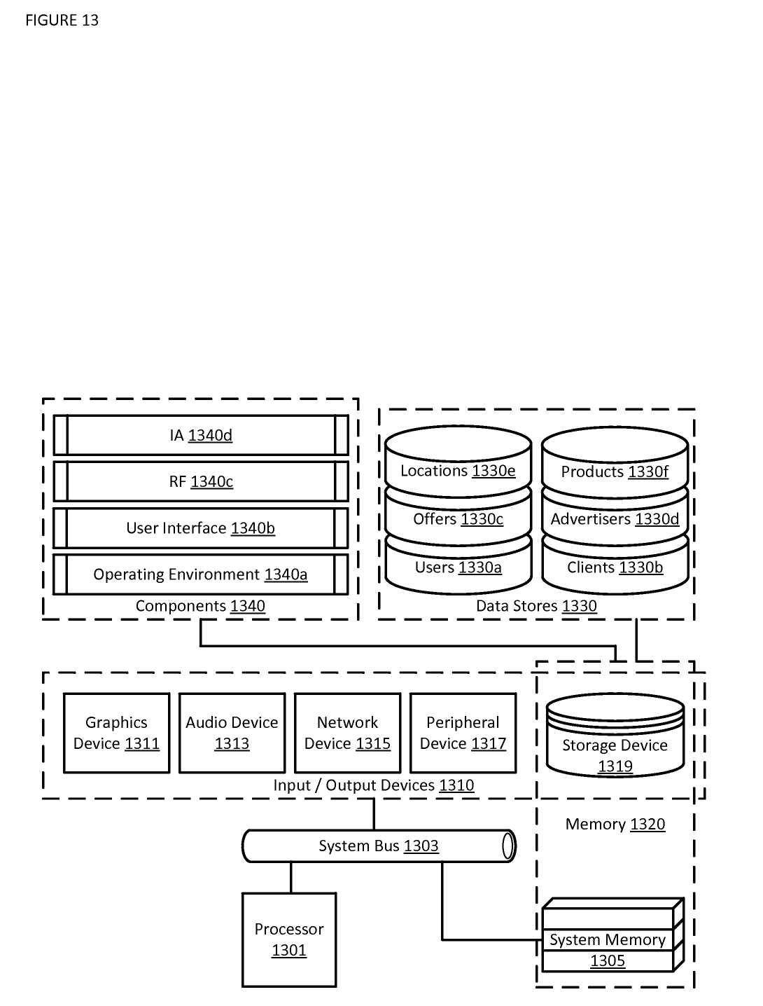

FIG. 13 shows a block diagram illustrating an exemplary PSP coordinator in one embodiment of the PSP. The PSP coordinator facilitates the operation of the PSP via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the PSP coordinator may receive, obtain, aggregate, process, generate, store, retrieve, send, delete, input, output, and/or the like data (including program data and program instructions); may execute program instructions; may communicate with computer systems, with nodes, with users, and/or the like. In various embodiments, the PSP coordinator may comprise a standalone computer system, a distributed computer system, a node in a computer network (i.e., a network of computer systems organized in a topology), a network of PSP coordinators, and/or the like. It is to be understood that the PSP coordinator and/or the various PSP coordinator elements (e.g., processor, system bus, memory, input/output devices) may be organized in any number of ways (i.e., using any number and configuration of computer systems, computer networks, nodes, PSP coordinator elements, and/or the like) to facilitate PSP operation. Furthermore, it is to be understood that the various PSP coordinator computer systems, PSP coordinator computer networks, PSP coordinator nodes, PSP coordinator elements, and/or the like may communicate among each other in any number of ways to facilitate PSP operation. As used in this disclosure, the term “user” refers generally to people and/or computer systems that interact with the PSP; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; the term “node” refers generally to a server, to a client, and/or to an intermediary computer system, program, and/or a combination thereof that facilitates transmission of and/or handling of requests and/or responses.

The PSP coordinator includes a processor 1301 that executes program instructions (e.g., PSP program instructions). In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may comprise one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be connected to system memory 1305 via a system bus 1303. The system bus may interconnect these and/or other elements of the PSP coordinator via electrical, electronic, optical, wireless, and/or the like communication links (e.g., the system bus may be integrated into a motherboard that interconnects PSP coordinator elements and provides power from a power supply). In various embodiments, the system bus may comprise one or more control buses, address buses, data buses, memory buses, peripheral buses, and/or the like. In various implementations, the system bus may be a parallel bus, a serial bus, a daisy chain design, a hub design, and/or the like. For example, the system bus may comprise a front-side bus, a back-side bus, AMD's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like. The system memory, in various embodiments, may comprise registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions (e.g., PSP program instructions) executed by the processor. The system memory may facilitate accessing, storing, retrieving, modifying, deleting, and/or the like data (e.g., PSP data) by the processor.

In various embodiments, input/output devices 1310 may be connected to the processor and/or to the system memory, and/or to one another via the system bus.

In some embodiments, the input/output devices may include one or more graphics devices 1311. The processor may make use of the one or more graphic devices in accordance with program instructions (e.g., PSP program instructions) executed by the processor. In one implementation, a graphics device may be a video card that may obtain (e.g., via a connected video camera), process (e.g., render a frame), output (e.g., via a connected monitor, television, and/or the like), and/or the like graphical (e.g., multimedia, video, image, text) data (e.g., PSP data). A video card may be connected to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 1313. The processor may make use of the one or more audio devices in accordance with program instructions (e.g., PSP program instructions) executed by the processor. In one implementation, an audio device may be a sound card that may obtain (e.g., via a connected microphone), process, output (e.g., via connected speakers), and/or the like audio data (e.g., PSP data). A sound card may be connected to the system bus via an interface such as PCI, PCI Express, USB, PC Card, ExpressCard, and/or the like. A sound card may be connected via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC'97 integrated codec chip, an Intel HD Audio integrated codec chip, a Creative Sound Blaster X-Fi Titanium HD, a Creative Sound Blaster X-Fi Go! Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 1315. The processor may make use of the one or more network devices in accordance with program instructions (e.g., PSP program instructions) executed by the processor. In one implementation, a network device may be a network card that may obtain (e.g., via a Category 5 Ethernet cable), process, output (e.g., via a wireless antenna), and/or the like network data (e.g., PSP data). A network card may be connected to the system bus via an interface such as PCI, PCI Express, USB, FireWire, PC Card, Express Card, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modem, FM radio modem, radio-frequency identification (RFID) modem, infrared (IR) modem), and/or the like. For example, a network card may be an Intel EXPI9301CT, an Intel EXPI9402PT, a LINKSYS USB300M, a BUFFALO WLI-UC-G450, a Rosewill RNX-MiniN1, a TRENDnet TEW-623PI, a Rosewill RNX-N180UBE, an ASUS USB-BT211, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 1317. The processor may make use of the one or more peripheral devices in accordance with program instructions (e.g., PSP program instructions) executed by the processor. In various implementations, a peripheral device may be a digital camera, a video camera, a webcam, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, sensors (e.g., proximity sensor, ambient temperature sensor, ambient light sensor, humidity sensor, an accelerometer, a gyroscope, a motion sensor, an olfaction sensor, a biosensor, a chemical sensor, a magnetometer, a radar, a location sensor such as global positioning system (GPS), Galileo, GLONASS, and/or the like), a printer, a fax, a scanner, a copier, a card reader, and/or the like. A peripheral device may be connected to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the PSP coordinator with a variety of input, output and processing capabilities.

In some embodiments, the input/output devices may include one or more storage devices 1319. The processor may access, read from, write to, store in, erase, modify, and/or the like a storage device in accordance with program instructions (e.g., PSP program instructions) executed by the processor. A storage device may facilitate accessing, storing, retrieving, modifying, deleting, and/or the like data (e.g., PSP data) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CO card, a secure digital extended capacity (SDXC) card), a network attached storage (NAS), a direct-attached storage (DAS), a storage area network (SAN), other processor-readable physical mediums, and/or the like. A storage device may be connected to the system bus via an interface such as PCI, PCI Express, USB, FireWire, PC Card, ExpressCard, integrated drive electronics (IDE), serial advanced technology attachment (SATA), external SATA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (JBOD), and/or the like may be used. In another example, virtual and/or physical drives may be pooled to create a storage pool. In yet another example, an SSD cache may be used with a HDD to improve speed.

Together and/or separately the system memory 1305 and the one or more storage devices 1319 may be referred to as memory 1320 (i.e., physical memory).

PSP memory 1320 contains processor-operable (e.g., accessible) PSP data stores 1330. Data stores 1330 comprise data that may be used (e.g., by the PSP) via the PSP coordinator. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, PSP coordinator elements, and/or the like) to facilitate PSP operation. For example, PSP data stores may comprise data stores 1330a-f implemented as one or more databases. A users data store 1330a may be a collection of database tables that include fields such as UserID, UserName, UserPreferences, UserLocation, UserPointsBalance, UserUnlockedOffers, UserSocialNetworkInfo, and/or the like. A clients data store 1330b may be a collection of database tables that include fields such as ClientID, ClientName, ClientDeviceType, ClientScreenResolution, and/or the like. An offers data store 1330c may be a collection of database tables that include fields such as OfferID, OfferDuration, OfferTitle, OfferText, OfferLocations, OfferCostToUnlock, OfferValue, and/or the like. An advertisers data store 1330d may be a collection of database tables that include fields such as AdvertiserID, AdvertiserName, AdvertiserDemographicsOfInterest, AdvertiserContactInfo, and/or the like. A locations data store 1330e may be a collection of database tables that include fields such as LocationID, LocationName, LocationGeographicCoordinates, LocationWorkingHours, LocationReviews, LocationProducts, LocationPrices, and/or the like. A products data store 1330f may be a collection of database tables that include fields such as ProductID, ProductName, ProductBrand, ProductMSRP, ProductCategory, ProductSubcategory, and/or the like. The PSP coordinator may use data stores 1330 to keep track of inputs, parameters, settings, variables, records, outputs, and/or the like.

PSP memory 1320 contains processor-operable (e.g., executable) PSP components 1340. Components 1340 comprise program components (including program instructions and any associated data stores) that are executed (e.g., by the PSP) via the PSP coordinator (i.e., via the processor) to transform PSP inputs into PSP outputs. It is to be understood that the various components and their subcomponents, capabilities, applications, and/or the like may be organized in any number of ways (i.e., using any number and configuration of components, subcomponents, capabilities, applications, PSP coordinator elements, and/or the like) to facilitate PSP operation. Furthermore, it is to be understood that the various components and their subcomponents, capabilities, applications, and/or the like may communicate among each other in any number of ways to facilitate PSP operation. For example, the various components and their subcomponents, capabilities, applications, and/or the like may be combined, integrated, consolidated, split up, distributed, and/or the like in any number of ways to facilitate PSP operation. In another example, a single or multiple instances of the various components and their subcomponents, capabilities, applications, and/or the like may be instantiated on each of a single PSP coordinator node, across multiple PSP coordinator nodes, and/or the like.

In various embodiments, program components may be developed using one or more programming languages, techniques, tools, and/or the like such as an assembly language, Ada, BASIC, C, C++, C#, COBOL, Fortran, Java, LabVIEW, Lisp, Mathematica, MATLAB, O Caml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), Simple Object Access Protocol (SOAP), SSL, ColdFusion, Microsoft .NET, Apache modules, Adobe Flash, Adobe AIR, Microsoft Silverlight, Windows PowerShell, batch files, Tcl, graphical user interface (GUI) toolkits, SQL, database adapters, web application programming interfaces (APIs), application server extensions, integrated development environments (IDEs), libraries (e.g., object libraries, class libraries, remote libraries), remote procedure calls (RPCs), Common Object Request Broker Architecture (CORBA), and/or the like.

In some embodiments, components 1340 may include an operating environment component 1340a. The operating environment component may facilitate operation of the PSP via various subcomponents.

In some implementations, the operating environment component may include an operating system subcomponent. The operating system subcomponent may provide an abstraction layer that facilitates the use of, communication among, common services for, interaction with, security of, and/or the like of various PSP coordinator elements, components, data stores, and/or the like.

In some embodiments, the operating system subcomponent may facilitate execution of program instructions (e.g., PSP program instructions) by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the PSP. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the PSP coordinator as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the PSP coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the PSP by providing user interface elements that may be used by the PSP to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo! User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may comprise a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may comprise an operating system such as UNIX, LINUX, IBM i, Sun Solaris, Microsoft Windows Server, Microsoft DOS, Microsoft Windows 7, Microsoft Windows 8, Apple Mac OS X, Apple iOS, Android, Symbian, Windows Phone 7, Windows Phone 8, Blackberry QNX, and/or the like.

In some implementations, the operating environment component may include a database subcomponent. The database subcomponent may facilitate PSP capabilities such as storage, analysis, retrieval, access, modification, deletion, aggregation, generation, and/or the like of data (e.g., the use of data stores 1330). The database subcomponent may make use of database languages (e.g., Structured Query Language (SQL), XQuery), stored procedures, triggers, APIs, and/or the like to provide these capabilities. In various embodiments the database subcomponent may comprise a cloud database, a data warehouse, a distributed database, an embedded database, a parallel database, a real-time database, and/or the like. For example, the database subcomponent may comprise a database such as Microsoft SQL Server, Microsoft Access, MySQL, IBM DB2, Oracle Database, and/or the like.

In some implementations, the operating environment component may include an information handling subcomponent. The information handling subcomponent may provide the PSP with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, PSP components, nodes in a computer network, web browsers, and/or the like. For example, the information handling subcomponent may comprise a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 1330) via the database subcomponent.

In some embodiments, the information handling subcomponent may facilitate presentation of information obtained from users, PSP components, nodes in a computer network, web servers, and/or the like. For example, the information handling subcomponent may comprise a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate PSP message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, and/or the like to facilitate PSP message communications. The messaging subcomponent may facilitate message communications such as email, instant messaging, Voice over IP (VoIP), video conferencing, Short Message Service (SMS), web chat, and/or the like. For example, the messaging subcomponent may comprise Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates PSP security. In some embodiments, the security subcomponent may restrict access to the PSP, to one or more services provided by the PSP, to data associated with the PSP (e.g., stored in data stores 1330), to communication messages associated with the PSP, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the PSP may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may comprise a cryptographic system such as Pretty Good Privacy (PGP).

In some implementations, the operating environment component may include a virtualization subcomponent that facilitates PSP virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may comprise VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 1340 may include a user interface component 1340b. The user interface component may facilitate user interaction with the PSP by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In some embodiments, components 1340 may include any of the components RF 1340c and IA 1340d described in more detail in preceding figures.

### The Embodiments of the PSP

The entirety of this disclosure (including the written description, figures, claims, abstract, appendices, and/or the like) for PRODUCT SCOUT PLATFORM METHODS, APPARATUSES AND MEDIA shows various embodiments via which the claimed innovations may be practiced. It is to be understood that these embodiments and the features they describe are a representative sample presented to assist in understanding the claimed innovations, and are not exhaustive and/or exclusive. As such, the various embodiments, implementations, examples, and/or the like are deemed non-limiting throughout this disclosure. Furthermore, alternate undescribed embodiments may be available (e.g., equivalent embodiments). Such alternate embodiments have not been discussed to preserve space and/or reduce repetition. That alternate embodiments have not been discussed is not to be considered a disclaimer of such alternate undescribed embodiments, and no inference should be drawn regarding such alternate undescribed embodiments relative to those discussed in this disclosure. It is to be understood that such alternate undescribed embodiments may be utilized without departing from the spirit and/or scope of the disclosure. For example, the organizational, logical, physical, functional, topological, and/or the like structures of various embodiments may differ. In another example, the organizational, logical, physical, functional, topological, and/or the like structures of the PSP coordinator, PSP coordinator elements, PSP data stores, PSP components and their subcomponents, capabilities, applications, and/or the like described in various embodiments throughout this disclosure are not limited to a fixed operating order and/or arrangement, instead, all equivalent operating orders and/or arrangements are contemplated by this disclosure. In yet another example, the PSP coordinator, PSP coordinator elements, PSP data stores, PSP components and their subcomponents, capabilities, applications, and/or the like described in various embodiments throughout this disclosure are not limited to serial execution, instead, any number and/or configuration of threads, processes, instances, services, servers, clients, nodes, and/or the like that execute in parallel, concurrently, simultaneously, synchronously, asynchronously, and/or the like is contemplated by this disclosure. Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, nonprovisional applications, continuation applications, continuation-in-part applications, divisional applications, and/or the like. It is to be understood that while some embodiments of the PSP discussed in this disclosure have been directed to a marketing platform for products (e.g., spirits, beer, wine, energy drinks, soda, cosmetics, fashion brands products, automotive products), the innovations described in this disclosure may be readily applied to a wide variety of other fields and/or applications.

The following is claimed:

1. A processor-implemented method to fulfill a rebate fulfillment request, comprising:
obtaining via a processor a rebate fulfillment request from a user;
determining via the processor that an offer associated with the rebate fulfillment request is unlocked for the user;
validating via the processor that offer terms associated with the offer are satisfied;
approving via the processor a rebate associated with the rebate fulfillment request; and
facilitating via the processor rebate fulfillment for the rebate.
